(19) United States
(12) Patent Application Publication
(10) Pub. No.: US 2025/0031673 A1
(43) Pub. Date: Jan. 30, 2025

(54) Leash-Less Collar Device

(71) Applicants: Bradley Cook, Pine Bluff, AR (US); Jacob Smart, Rison, AR (US)

(72) Inventors: Bradley Cook, Pine Bluff, AR (US); Jacob Smart, Rison, AR (US)

(21) Appl. No.: 18/403,214

(22) Filed: Jan. 3, 2024

Related U.S. Application Data
(60) Provisional application No. 63/516,100, filed on Jul. 27, 2023.

(51) Int. Cl. A01K 27/00; A01K 15/02

(52) U.S. Cl. CPC A01K 27/001; A01K 15/023; A01K 27/009

(57) ABSTRACT

A leash-less collar device is provided. In one embodiment, the device is comprised of a pet collar with a vibration motor and/or a shocking mechanism. A user can use a fob and/or a mobile application to set a boundary distance between the fob and/or smart device the mobile application is installed on. If the pet exceeds the boundary distance when wearing the collar, the collar delivers a vibration and/or shock. In another embodiment, the device is comprised of a bracelet instead of a collar, wherein the bracelet can be worn by a child and a user can use a fob and/or a mobile application to set a boundary distance between the fob and/or smart device the mobile application is installed on. If the child exceeds the boundary distance when wearing the bracelet, the bracelet delivers a vibration.

### CROSS-REFERENCE TO RELATED APPLICATION

The present application claims priority to, and the benefit of, U.S. Provisional Application No. 63/516,100, which was filed on Jul. 27, 2023, and is incorporated herein by reference in its entirety.

### FIELD OF THE INVENTION

The present invention relates generally to the field of containment devices. More specifically, the present invention relates to a leash-less collar device that can be applied to a pet via a collar or a child via a bracelet, wherein the device is comprised of a boundary distance that when exceeded corrects the pet/child and notifies the user that the distance has been exceeded. Accordingly, the present disclosure makes specific reference thereto. Nonetheless, it is to be appreciated that aspects of the present invention are also equally applicable to other like applications, devices, and methods of manufacture.

### BACKGROUND

Outside of the home, pet owners yearn for the assurance that their pet will remain within a close proximity. This proximity not only ensures the safety of the pet but also provides the owner with a sense of security and comfort. Traditional methods, such as using a leash, often come with their own set of challenges. Leashes can lead to uncomfortable pulling, potentially causing strain on the pet's neck or body. Moreover, there's the ever-present danger of entanglement which can lead to accidents or injuries for both the pet and the owner.

In the absence of a dependable mechanism to ensure the pet stays close, there are heightened concerns. Pets, driven by curiosity or fear, might dash off unexpectedly. This could result in them venturing into busy roads, facing the peril of oncoming traffic, or wandering off to unfamiliar territories and getting lost.

Similarly, parents of young children can resonate with these anxieties. The thought of their children straying away, even for a moment, can be deeply unsettling. Just like pets, children are curious and can easily get distracted, leading them to wander off. As a result, parents constantly seek reliable ways to ensure their children's safety by keeping said children close, especially in crowded or unfamiliar environments.

Therefore, there exists a long-felt need in the art for a device that ensures a pet or a child stays close to an owner/parent. More specifically, there exists a long-felt need in the art for a leash-less collar device that can be placed on a pet, wherein the device allows a user to set a boundary distance that the pet cannot travel beyond. There also exists a long-felt need in the art for a leash-less collar device that corrects the pet when the pet travels beyond the boundary distance. In addition, there exists a long-felt need in the art for a leash-less collar device that alerts an owner when a pet travels beyond the boundary distance. Further, there exists a long-felt need in the art for a device that can be placed on a child, wherein the device allows a user to set a boundary distance that the child cannot travel beyond. There also exists a long-felt need in the art for a device that corrects the child when the child travels beyond the boundary distance, and that also alerts a user when a child travels beyond the boundary distance.

The subject matter disclosed and claimed herein, in one embodiment thereof, comprises a leash-less collar device. In one embodiment, the device is comprised of a pet collar with a vibration motor and/or a shocking mechanism. A user can use a fob and/or a mobile application to set a boundary distance between the fob and/or smart device the mobile application is installed on. If the pet exceeds the boundary distance when wearing the collar, the collar delivers a vibration and/or shock. The fob/mobile application also alerts the user that the distance was exceeded via a notification or alert. In another embodiment, the device is comprised of a bracelet instead of a collar, wherein the bracelet can be worn by a child. This embodiment is only comprised of a vibration motor. A user can use a fob and/or a mobile application to set a boundary distance between the fob and/or smart device the mobile application is installed on. If the child exceeds the boundary distance when wearing the bracelet, the bracelet delivers a vibration. The fob/mobile application also alerts the user that the distance was exceeded via a notification or alert.

In this manner, the leash-less collar device of the present invention accomplishes all the forgoing objectives and provides a device that ensures a pet or a child stays close to an owner/parent. More specifically, the device allows a user to set a boundary distance that the pet cannot travel beyond and that corrects the pet when the pet travels beyond the boundary distance. In addition, the device that alerts an owner when a pet travels beyond the boundary distance. Further, the device can be placed on a child, wherein the device allows a user to set a boundary distance that the child cannot travel beyond and that corrects the child when the child travels beyond the boundary distance. The device also alerts a user when a child travels beyond the boundary distance.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a leash-less collar device. In one embodiment, the device is comprised of at least one pet collar with at least one vibration motor and/or at least one shocking mechanism, wherein the collar delivers a vibration and/or a shock if a pet moves outside of a boundary distance set by a fob and/or mobile application. In a different embodiment, the device is comprised of at least one bracelet that can be worn by a child, wherein the bracelet delivers at least one vibration via the motor if a child moves outside of at least one boundary distance set by a fob and/or mobile application.

The collar and/or bracelet is comprised of at least one housing preferably comprised of at least one vibration motor. The motor delivers at least one vibration to the animal/human wearing the collar. In one embodiment, the motor has a plurality of vibration intensities that can be controlled, selected, and configured by a fob and/or a mobile application.

In an embodiment wherein the device is comprised of a collar, the housing positioned on the collar may also be comprised of at least one shocking mechanism. The mechanism delivers an electric shock to the animal wearing the collar. The mechanism may have a plurality of shock intensities that can be controlled, selected, and configured by a fob and/or mobile application.

The motor and/or shocking mechanism can be controlled via at least one fob in one embodiment, wherein at least one receiver of the housing is in wireless electrical communication, via Bluetooth, wi-fi, etc., with at least one transmitter of the fob. Using the fob, a user can set at least one boundary distance for the housing. More specifically, the boundary distance is the distance away from the fob that the housing can travel before delivering at least one vibration via the motor and/or at least one shock via the mechanism to the animal wearing the collar. Using at least one button of the fob, a user can use at least one display on the fob to set a specific boundary distance. Once the boundary distance is exceeded, the fob may also produce at least one audible alert, sound, etc. via at least one speaker of the fob.

The device may also be comprised of a mobile application that can be installed on a smart device that is in wireless electrical communication with the receiver of the housing. The mobile application preferably has all features and capabilities of the fob. For example, the application allows a user to set the boundary distance. The distance may be set specifically (ex. 5 feet) or generally (ex. short distance, medium distance, long distance, etc.).

The application is also comprised of a notification feature that alerts a user when the housing exceeds a boundary distance from the smart device and/or fob. The feature may then produce a notification such as but not limited to an audible alert, a push notification, a call, a text, an email, an app notification, etc. The application may also allow a user to set an intensity, frequency, and usage (i.e., on/off) of the motor and the shocking mechanism.

The present invention is also comprised of a method of using the device. First, a device is provided comprised of a collar comprised of a housing with at least one vibration motor and/or at least one shocking mechanism, wherein the housing is in wireless electrical communication with at least one fob and/or at least one mobile application. Then, a user can set a boundary distance between the fob and housing via the fob and/or the mobile application such that when the boundary distance is exceeded by an animal wearing the housing, the housing delivers at least one vibration from the motor and/or at least one shock from the shocking mechanism. A user can also use the fob and/or mobile application to configure the intensity, frequency, and usage (i.e., on/off) of the vibration and/or the shock.

The present invention is also comprised of a second method of using the device. First, a device is provided comprised of a bracelet comprised of a housing with at least one vibration motor in wireless electrical communication with at least one fob and/or at least one mobile application. Then, a user can set a boundary distance between the fob and housing via the fob and/or the mobile application such that when the boundary distance is exceeded by a child wearing the housing, the housing delivers at least one vibration from the motor. A user can also use the fob and/or mobile application to configure the intensity, frequency, and usage (i.e., on/off) of the vibration.

Accordingly, the leash-less collar device of the present invention is particularly advantageous as it provides a device that ensures a pet or a child stays close to an owner/parent. More specifically, the device allows a user to set a boundary distance that the pet cannot travel beyond and that corrects the pet when the pet travels beyond the boundary distance. In addition, the device that alerts an owner when a pet travels beyond the boundary distance. Further, the device can be placed on a child, wherein the device allows a user to set a boundary distance that the child cannot travel beyond and that corrects the child when the child travels beyond the boundary distance. The device also alerts a user when a child travels beyond the boundary distance. In this manner, the leash-less collar device overcomes the limitations of existing methods of keeping pets and children close known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a collar embodiment of a leash-less collar device of the present invention in accordance with the disclosed architecture;

FIG. 2 illustrates a perspective view of a bracelet embodiment of a leash-less collar device of the present invention in accordance with the disclosed architecture;

FIG. 3 illustrates a graphical view of features of a mobile application of one potential embodiment of a leash-less collar device of the present invention in accordance with the disclosed architecture;

FIG. 4 illustrates a flowchart of a method of using one potential embodiment of a leash-less collar device of the present invention in accordance with the disclosed architecture; and

FIG. 5 illustrates a flowchart of a method of using one potential embodiment of a leash-less collar device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that ensures a pet or a child stays close to an owner/parent. More specifically, there exists a long-felt need in the art for a leash-less collar device that can be placed on a pet, wherein the device allows a user to set a boundary distance that the pet cannot travel beyond. There also exists a long-felt need in the art for a leash-less collar device that corrects the pet when the pet travels beyond the boundary distance. In addition, there exists a long-felt need in the art for a leash-less collar device that alerts an owner when a pet travels beyond the boundary distance. Further, there exists a long-felt need in the art for a device that can be placed on a child, wherein the device allows a user to set a boundary distance that the child cannot travel beyond. There also exists a long-felt need in the art for a device that corrects the child when the child travels beyond the boundary distance, and that also alerts a user when a child travels beyond the boundary distance.

The present invention, in one exemplary embodiment, is comprised of a leash-less collar device. In one embodiment, the device is comprised of at least one pet collar with at least one vibration motor and/or at least one shocking mechanism. In this embodiment, the collar delivers a vibration and/or a shock if a pet moves outside of a boundary distance set by a fob and/or mobile application. In a different embodiment, the device is comprised of at least one bracelet that can be worn by a child. In this embodiment, the bracelet delivers at least one vibration via the motor if a child moves outside of at least one boundary distance set by a fob and/or mobile application.

The collar and/or bracelet is comprised of at least one housing preferably comprised of at least one vibration motor. The motor delivers at least one vibration to the animal/human wearing the collar. In one embodiment, the motor has a plurality of vibration intensities that can be controlled, selected, and configured by a fob and/or a mobile application.

In an embodiment wherein the device is comprised of a collar, the housing positioned on the collar may also be comprised of at least one shocking mechanism. The mechanism delivers an electric shock to the animal wearing the collar. The mechanism may have a plurality of shock intensities that can be controlled, selected, and configured by a fob and/or mobile application.

The motor and/or shocking mechanism can be controlled via at least one fob in one embodiment, wherein at least one receiver of the housing is in wireless electrical communication, via Bluetooth, wi-fi, etc., with at least one transmitter of the fob. Using the fob, a user can set at least one boundary distance for the housing. More specifically, the boundary distance is the distance away from the fob that the housing can travel before delivering at least one vibration via the motor and/or at least one shock via the mechanism to the animal wearing the collar. Using at least one button of the fob, a user can use at least one display on the fob to set a specific boundary distance. Once the boundary distance is exceeded, the fob may also produce at least one audible alert, sound, etc. via at least one speaker of the fob.

The device may also be comprised of a mobile application that can be installed on a smart device that is in wireless electrical communication with the receiver of the housing. The mobile application preferably has all features and capabilities of the fob. For example, the application allows a user to set the boundary distance. The distance may be set specifically (ex. 5 feet) or generally (ex. short distance, medium distance, long distance, etc.).

The application is also comprised of a notification feature that alerts a user when the housing exceeds a boundary distance from the smart device and/or fob. The feature may then produce a notification such as but not limited to an audible alert, a push notification, a call, a text, an email, an app notification, etc. The application may also allow a user to set an intensity, frequency, and usage (i.e., on/off) of the motor and the shocking mechanism.

The present invention is also comprised of a method of using the device. First, a device is provided comprised of a collar comprised of a housing with at least one vibration motor and/or at least one shocking mechanism, wherein the housing is in wireless electrical communication with at least one fob and/or at least one mobile application. Then, a user can set a boundary distance between the fob and housing via the fob and/or the mobile application such that when the boundary distance is exceeded by an animal wearing the housing, the housing delivers at least one vibration from the motor and/or at least one shock from the shocking mechanism. A user can also use the fob and/or mobile application to configure the intensity, frequency, and usage (i.e., on/off) of the vibration and/or the shock.

The present invention is also comprised of a second method of using the device. First, a device is provided comprised of a bracelet comprised of a housing with at least one vibration motor in wireless electrical communication with at least one fob and/or at least one mobile application. Then, a user can set a boundary distance between the fob and housing via the fob and/or the mobile application such that when the boundary distance is exceeded by a child wearing the housing, the housing delivers at least one vibration from the motor. A user can also use the fob and/or mobile application to configure the intensity, frequency, and usage (i.e., on/off) of the vibration.

Accordingly, the leash-less collar device of the present invention is particularly advantageous as it provides a device that ensures a pet or a child stays close to an owner/parent. More specifically, the device allows a user to set a boundary distance that the pet cannot travel beyond and that corrects the pet when the pet travels beyond the boundary distance. In addition, the device that alerts an owner when a pet travels beyond the boundary distance. Further, the device can be placed on a child, wherein the device allows a user to set a boundary distance that the child cannot travel beyond and that corrects the child when the child travels beyond the boundary distance. The device also alerts a user when a child travels beyond the boundary distance. In this manner, the leash-less collar device overcomes the limitations of existing methods of keeping pets and children close known in the art.

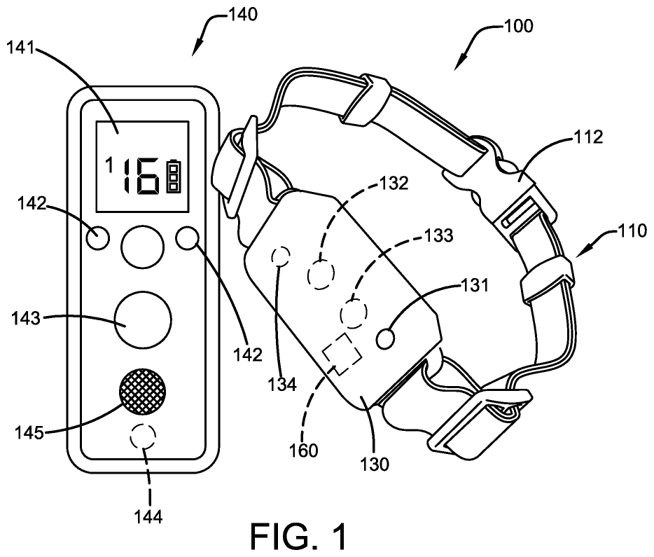

Referring initially to the drawings, FIG. 1 illustrates a perspective view of collar embodiment of a leash-less collar device 100 of the present invention in accordance with the disclosed architecture. In the preferred embodiment, the device 100 is comprised of at least one pet collar 110 with at least one vibration motor 132 and/or at least one shocking mechanism 133, wherein the collar 110 delivers a vibration and/or a shock if a pet moves outside of a boundary distance set by a fob 140 and/or mobile application 150. In a different embodiment, the device 100 is comprised of at least one bracelet 120 that can be worn by a child, wherein the bracelet 120 delivers at least one vibration via the motor 132 if a child moves outside of at least one boundary distance set by a fob 140 and/or mobile application 150.

The collar 110 may be any type, size, and configuration of animal collar known in the art. This includes but is not limited to a martingale collar, a breakaway collar, a prong collar, a choke chain collar, a reflective collar, a safety collar, etc. The collar 110 may have at least one fastener 112 that secures the collar 110 around the neck (or other body area) of an animal. The fastener 112 may be but is not limited to a buckle, a magnet, a clasp, etc. The collar 110 may also be size adjustable via any mechanism known in the art.

The collar 110 is comprised of at least one housing 130. The housing 130 is preferably comprised of at least one vibration motor 132. The motor 132 delivers at least one vibration to the pet wearing the collar 110. In one embodiment, the motor 132 has a plurality of vibration intensities that can be controlled, selected, and configured by a fob 140 and/or a mobile application 150.

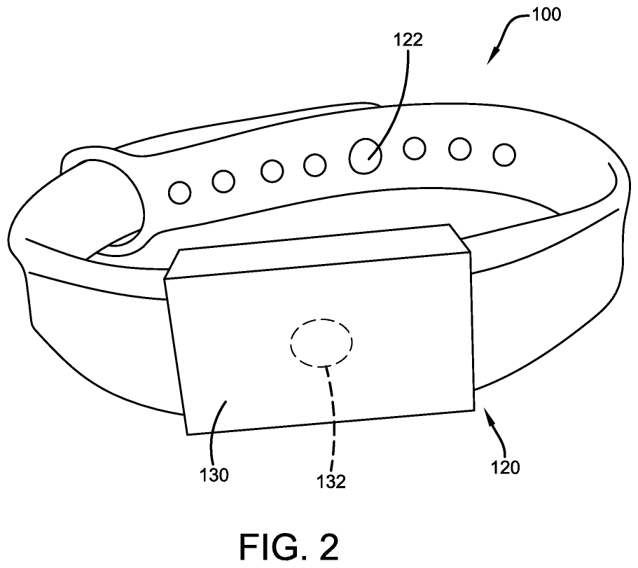

In an embodiment where the device 100 is comprised of a bracelet 120 instead of a collar 110 (as seen in FIG. 2), wherein the bracelet 120 intended to be worn by a child (or other human), the bracelet 120 may be comprised of at least one fastener 122. The fastener 122 secures the bracelet 120 around a body area of the wearer. The fastener 122 may be but is not limited to a buckle, a magnet, a clasp, etc. The bracelet 120 may also be size adjustable via any mechanism known in the art. The housing 130 of the bracelet 120 in this embodiment is only comprised of a vibration motor 132 and has no shock capabilities.

In an embodiment wherein the device 100 is comprised of a collar 110, the housing 130 positioned on the collar 110 may also be comprised of at least one shocking mechanism 133. The mechanism 133 delivers an electric shock to the animal wearing the collar 110. The shocking mechanism 133 may be any mechanism known in the art that can create an electric shock. The mechanism 133 may have a plurality of shock intensities that can be controlled, selected, and configured by a fob 140 and/or mobile application 150.

The motor 132 and/or shocking mechanism 133 can be controlled via at least one fob 140 in one embodiment. In this embodiment, at least one receiver 134 of the housing 130 is in wireless electrical communication, via Bluetooth, wi-fi, etc., with at least one transmitter 144 of the fob 140. In one embodiment, the successful pairing/communication status between the fob 140 and housing 130 is shown via at least one indicator LED 131 on the housing 130 and/or at least one indicator LED 131 on the fob 140. When the housing 130 and fob 140 are paired, the LEDs 131,142 may illuminate a first color. When the housing 130 and fob 140 are not paired, the LEDs 131,142 may illuminate a second color. The LEDs 131,142 may illuminate a third color when in pairing mode.

Using the fob 140, a user can set at least one boundary distance for the housing 130. More specifically, the boundary distance is the distance away from the fob 140 that the housing 130 can travel before delivering at least one vibration via the motor 132 and/or at least one shock via the mechanism 133 to the animal wearing the collar 110. Using at least one button 143 of the fob 140, a user can use at least one display 141 on the fob 140 to set a specific boundary distance. In another embodiment, the fob 140 is comprised of at least one boundary distance LED 142. In this embodiment, number of LEDs 142 illuminated indicates the length of the boundary distance. For example, if one LED 142 is illuminated, the boundary distance is a shorter distance than if two LEDs 142 are illuminated. Once the boundary distance is exceeded, the fob 140 may also produce at least one audible alert, sound, etc. via at least one speaker 145 of the fob 140.

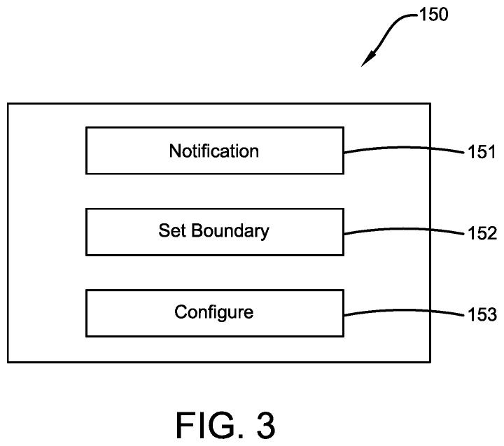

The device 100 may also be comprised of a mobile application 150, as seen in FIG. 3. The application 150 can be installed on any smart device such as but not limited to a cell phone, a tablet, a computer, etc. The smart device can then be placed in wireless communication, via Bluetooth, Wi-Fi, etc., with the receiver 134 of the housing 130. The mobile application 150 preferably has all features and capabilities of the fob 140. For example, the application 150 allows a user to set the boundary distance 152. The distance 152 may be set specifically (ex. 5 feet) or generally (ex. short distance, medium distance, long distance, etc.).

The application 150 is also comprised of a notification feature 151. The feature 151 alerts a user when the housing 130 exceeds a boundary distance 130 from the smart device and/or fob 140. The feature 151 may then produce a notification such as but not limited to an audible alert, a push notification, a call, a text, an email, an app notification, etc. The application 150 may also allow a user to set an intensity, frequency, and usage (i.e., on/off) 153 of the motor 132 and the shocking mechanism 133.

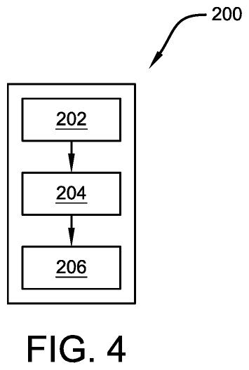

The present invention is also comprised of a method of using 200 the device 100, as seen in FIG. 4. First, a device 100 is provided comprised of a collar 110 comprised of a housing 130 with at least one vibration motor 132 and/or at least one shocking mechanism 133, wherein the housing 130 is in wireless electrical communication with at least one fob 140 and/or at least one mobile application 150 [Step 202]. Then, a user can set a boundary distance between the fob 140 and housing 130 via the fob 140 and/or the mobile application 150 such that when the boundary distance is exceeded by an animal wearing the housing 130, the housing 130 delivers at least one vibration from the motor 132 and/or at least one shock from the shocking mechanism 133 [Step 204]. A user can also use the fob 140 and/or mobile application 150 to configure the intensity, frequency, and usage (i.e., on/off) of the vibration and/or the shock [Step 206].

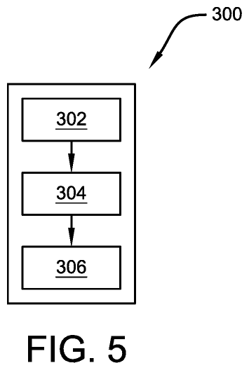

The present invention is also comprised of a second method of using 300 the device 100, as seen in FIG. 5. First, a device 100 is provided comprised of a bracelet 120 comprised of a housing 130 with at least one vibration motor 132 in wireless electrical communication with at least one fob 140 and/or at least one mobile application 150 [Step 302]. Then, a user can set a boundary distance between the fob 140 and housing 130 via the fob 140 and/or the mobile application 150 such that when the boundary distance is exceeded by a child wearing the housing 130, the housing 130 delivers at least one vibration from the motor 132 [Step 304]. A user can also use the fob 140 and/or mobile application to configure the intensity, frequency, and usage (i.e., on/off) of the vibration [Step 306].

In any embodiment, the device 100 may be comprised of at least one disposable or rechargeable battery 160.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “leash-less collar device” and “device” are interchangeable and refer to the leash-less collar device 100 of the present invention.

Notwithstanding the forgoing, the leash-less collar device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the leash-less collar device 100 as shown in the FIGS. are for illustrative purposes only, and that many other sizes and shapes of the leash-less collar device 100 are well within the scope of the present disclosure. Although the dimensions of the leash-less collar device 100 are important design parameters for user convenience, the leash-less collar device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A leash-less collar device comprising:
a collar comprised of a fastener;
a housing positioned on the collar, the housing comprised of a vibration motor, a shocking mechanism, and a receiver; and
a fob comprised of a transmitter.

2. The leash-less collar device of claim 1, wherein the fob is comprised of a display.

3. The leash-less collar device of claim 1, wherein the fob is comprised of a button.

4. The leash-less collar device of claim 1, wherein the fob creates a boundary distance between the housing and the fob.

5. The leash-less collar device of claim 4, wherein when the boundary distance is exceeded, the vibration motor produces a vibration.

6. The leash-less collar device of claim 4, wherein when the boundary distance is exceeded, the shocking mechanism produces an electric shock.

7. The leash-less collar device of claim 1 further comprised of a mobile application.

8. The leash-less collar device of claim 7, wherein the mobile application creates a boundary distance between the housing and a smart device that fob is installed on.

9. The leash-less collar device of claim 8, wherein when the boundary distance is exceeded, the vibration motor produces a vibration.

10. The leash-less collar device of claim 8, wherein when the boundary distance is exceeded, the shocking mechanism produces an electric shock.

11. A leash-less collar device comprising:
a bracelet comprised of a fastener;
a housing positioned on the collar, the housing comprised of a vibration motor and a receiver; and
a fob comprised of a transmitter.

12. The leash-less collar device of claim 11, wherein the fob is comprised of a display.

13. The leash-less collar device of claim 11, wherein the fob is comprised of a button.

14. The leash-less collar device of claim 11, wherein the fob creates a boundary distance between the housing and the fob.

15. The leash-less collar device of claim 14, wherein when the boundary distance is exceeded, the vibration motor produces a vibration.

16. The leash-less collar device of claim 11 further comprised of a mobile application.

17. The leash-less collar device of claim 16, wherein the mobile application creates a boundary distance between the housing and a smart device that fob is installed on.

18. The leash-less collar device of claim 17, wherein when the boundary distance is exceeded, the vibration motor produces a vibration.

19. A method of using a leash-less collar device, the method comprising the following steps:
providing a leash-less collar device comprised of a collar comprised of a housing comprised of a vibration motor and a shocking mechanism, and a fob or a mobile application;
setting a boundary distance between the fob or the mobile application and the housing; and
configuring an intensity, a frequency, or a usage of the vibration motor or the shocking mechanism via the fob or the mobile application.

20. The method of using a leash-less collar device of claim 19, wherein the fob is comprised of a display.
